(19) United States
(12) Patent Application Publication
(10) Pub. No.: US 2023/0349750 A1
(43) Pub. Date: Nov. 2, 2023

(54) STRUCTURE DETERIORATION DETECTION SYSTEM, STRUCTURE DETERIORATION DETECTION METHOD, AND STRUCTURE DETERIORATION DETECTION DEVICE

(71) Applicant: NEC Corporation, Minato-ku, Tokyo (JP)

(72) Inventors: Yuji Kobayashi, Tokyo (JP); Yoshiaki Sakae, Tokyo (JP); Hiroki Tagato, Tokyo (JP); Kazuhiko Isoyama, Tokyo (JP); Jun Nishioka, Tokyo (JP)

(73) Assignee: NEC Corporation, Minato-ku, Tokyo (JP)

(21) Appl. No.: 17/794,019

(22) PCT Filed: Jan. 30, 2020
(86) PCT No.: PCT/JP2020/003519

§ 371 Date: Jul. 20, 2022

(51) Int. Cl. G01H 9/00

(52) U.S. Cl. CPC G01H 9/004; E01C 23/01

(57) ABSTRACT

A structure deterioration detection system according to the present disclosure includes: a sensing optical fiber (10) laid on a structure; a reception unit (201) that receives vibration information detected by the sensing optical fiber (10); an identification unit (202) that identifies a change pattern of a vibration characteristic of each of a plurality of points on the structure, based on the vibration information; and an analysis unit (203) that analyzes a deterioration state of at least one point among the plurality of points, based on a change pattern of a vibration characteristic of each of the plurality of points.

### TECHNICAL FIELD

The present disclosure relates to a structure deterioration detection system, a structure deterioration detection method, and a structure deterioration detection device.

### BACKGROUND ART

On a road with asphalt pavement, a hole called pothole may be developed due to deterioration. Since a pothole developed on a road may induce a traffic accident, it is necessary to detect road deterioration at an early stage. Therefore, recently, a technique for detecting road deterioration at an early stage has been proposed (for example, Patent Literature 1).

In the technique described in Patent Literature 1, an prove vehicle equipped with a radar system non-destructively examines an internal damaged part of a pavement under a target surface while traveling on a pavement road surface. Specifically, an electromagnetic wave radar is irradiated from a radar system mounted on the prove vehicle to an inspection point on the target surface. Then, a reflected wave of the electromagnetic wave radar is detected in time series, an intensity of the reflected wave at a detection point is set as discrete data for each predetermined elapsed time or depth, and these data are statistically analyzed as test data. On the basis of a scattering degree of the test data, presence or absence of internal damage to the pavement under the target surface is determined.

### CITATION LIST

### Patent Literature

[Patent Literature 1] Japanese Patent No. 5701109

### SUMMARY OF INVENTION

### Technical Problem

However, the technique described in Patent Literature 1 has a problem that, in order to detect the road deterioration, it is necessary that a dedicated probe vehicle travels on the road, which increases an operation cost.

Recently, there has been an increasing need to detect deterioration not only in roads but also in other structures such as a bridge and a tunnel.

Therefore, an object of the present disclosure is to provide a structure deterioration detection system, a structure deterioration detection method, and a structure deterioration detection device that are capable of solving the above-mentioned problem and detecting a deterioration state of a structure at low cost.

### Solution to Problem

A structure deterioration detection system according to one aspect includes:
a sensing optical fiber laid on a structure;
a reception unit configured to receive vibration information detected by the sensing optical fiber;
an identification unit configured to identify a change pattern of a vibration characteristic of each of a plurality of points on the structure, based on the vibration information; and an analysis unit configured to analyze a deterioration state of at least one point among the plurality of points, based on a change pattern of a vibration characteristic of each of the plurality of points.

A structure deterioration detection method according to one aspect is a structure deterioration detection method performed by a structure deterioration detection system, and includes:
a reception step of receiving vibration information detected by a sensing optical fiber laid on a structure;
an identification step of identifying a change pattern of a vibration characteristic of each of a plurality of points on the structure, based on the vibration information; and
an analysis step of analyzing a deterioration state of at least one point among the plurality of points, based on a change pattern of a vibration characteristic of each of the plurality of points.

A structure deterioration detection device according to one aspect includes:
a reception unit configured to receive vibration information detected by a sensing optical fiber laid on a structure;
an identification unit configured to identify a change pattern of a vibration characteristic of each of a plurality of points on the structure, based on the vibration information; and
an analysis unit configured to analyze a deterioration state of at least one point among the plurality of points, based on a change pattern of a vibration characteristic of each of the plurality of points.

### Advantageous Effects of Invention

According to the above-mentioned aspect, it is possible to provide a structure deterioration detection system, a structure deterioration detection method, and a structure deterioration detection device that are capable of detecting a deterioration state of a structure at low cost.

### BRIEF DESCRIPTION OF DRAWINGS

FIG. 1 is a diagram illustrating a configuration example of a structure deterioration detection system according to a first example embodiment.

FIG. 2 is a diagram illustrating an example of contents of an association table held by an identification unit according to the first example embodiment.

FIG. 3 is a diagram illustrating an example in which a change pattern of a natural frequency of a road is resolved into a change pattern of the natural frequency depending on a surrounding condition of the road and a change pattern of the natural frequency depending on a deterioration state of the road.

FIG. 4 is a flow chart illustrating an example of an overall operation flow of the structure deterioration detection system according to the first example embodiment.

FIG. 5 is a block diagram illustrating a configuration example of a structure deterioration detection device according to a second example embodiment.

FIG. 6 is a diagram illustrating an example of contents of a natural frequency DB according to the second example embodiment.

FIG. 7 is a diagram illustrating an example of contents of a cluster DB according to the second example embodiment.

FIG. 8 is a diagram illustrating an example of an operation of calculating common time series data and an operation of correcting time series data of a natural frequency of a point to be analyzed, which are performed by a natural frequency correction unit according to the second example embodiment.

FIG. 9 is a diagram illustrating an example of a mechanism by which a pothole is developed on a road.

FIG. 10 is a diagram illustrating an example of time-series data after correction on a natural frequency of a point on a road where a pothole is developed.

FIG. 11 is a flow chart illustrating an example of an operation flow of determining, in a structure deterioration detection system according to the second example embodiment, a cluster to which each of a plurality of points on a road belongs.

FIG. 12 is a diagram illustrating an example of information exchanged between components included in the structure deterioration detection device according to the second example embodiment during the operation illustrated in FIG. 11.

FIG. 13 is a flow chart illustrating an example of an operation flow of detecting, in the structure deterioration detection system according to the second example embodiment, deterioration and a sign of deterioration in the point to be analyzed on the road.

FIG. 14 is a diagram illustrating an example of information exchanged between the components included in the structure deterioration detection device according to the second example embodiment during the operation illustrated in FIG. 13.

FIG. 15 is a block diagram illustrating an example of a hardware configuration of a computer that realizes the structure deterioration detection device according to the example embodiments.

### EXAMPLE EMBODIMENT

Example embodiments of the present disclosure will be described below with reference to the drawings. Note that the following description and the drawings are appropriately omitted and simplified for clarity of description. In the following drawings, the same components are denoted by the same reference signs, and a repetitive description thereof is omitted as necessary.

### First Example Embodiment

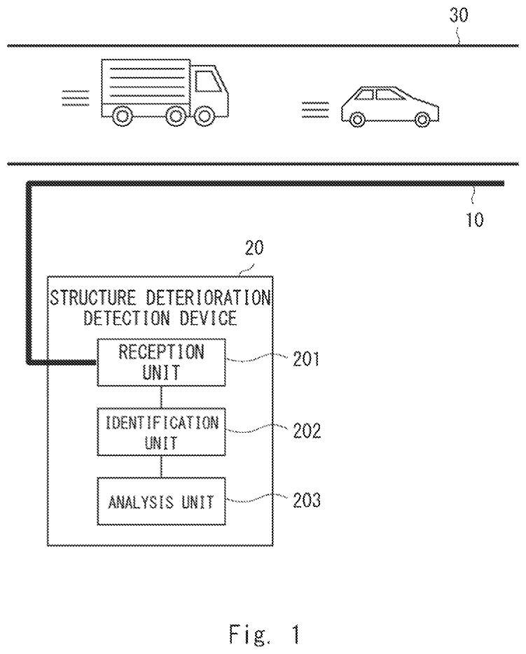

First, with reference to FIG. 1, a configuration example of s structure deterioration detection system according to s first example embodiment will be described. In the first example embodiment, it is assumed that s structure to be analyzed is s road 30, but the structure to be analyzed is not limited to the road 30.

As illustrated in FIG. 1, the structure deterioration detection system according to the first example embodiment includes a sensing optical fiber 10 and a structure deterioration detection device 20. The structure deterioration detecting device 20 includes a reception unit 201, an identification unit 202, and an analysis unit 203.

The sensing optical fiber 10 is laid along the road 30. In FIG. 1, it is assumed that the sensing optical fiber 10 is laid on a side of the road 30, but a method of laying the sensing optical fiber 10 is not limited thereto. For example, the sensing optical fiber 10 may be buried under the road 30. The sensing optical fiber 10 may be laid on the road 30 in a form of a cable formed by cladding one or more sensing optical fibers 10. The sensing optical fiber 10 may be an existing communication optical fiber or a newly installed optical fiber.

It is assumed that the road 30 is a structure in which asphalt pavement is applied and has a possibility of developing a pothole due to deterioration. The road 30 may be a highway or a general road, as long as the sensing optical fiber is laid.

The reception unit 201 inputs the pulsed light into the sensing optical fiber 10, and receives, through the sensing optical fiber 10, as return light (an optical signal), reflected light and scattered light generated by the pulsed light being transmitted through the sensing optical fiber 10.

Herein, when the road 30 vibrates, the vibration is transmitted to the sensing optical fiber 10, and a characteristic (for example, a wavelength) of the return light transmitted to the sensing optical fiber 10 changes. Therefore, the sensing optical fiber 10 can detect vibration information indicating the vibration of the road 30, (specifically, vibration information indicating a vibration value at each time). In addition, the return light transmitted through the sensing optical fiber 10 includes the vibration information of the road 30 detected by the sensing optical fiber 10 because its characteristic changes in accordance with the vibration information of the road 30 detected by the sensing optical fiber 10.

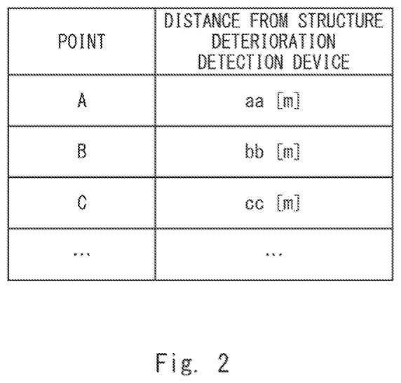

The identification unit 202 holds in advance an association table in which, for each of a plurality of points on the road 30, an identification number for identifying the point and positional information of the point (positional information indicating a distance from the structure deterioration detecting device 20) are associated with each other. FIG. 2 illustrates an example of contents of the association table.

Further, the identification unit 202 can identify at which position (distance from the structure deterioration detecting device 20) on the sensing optical fiber the return light is generated, based on, for example, a time difference between when the reception unit 201 transmits the pulsed light to the sensing optical fiber and when the reception unit 201 receives the return light, an intensity of the return light received by the reception unit 201, and the like.

Therefore, the identification unit 202 can identify at which point on the road 30 the return light is generated, by checking the position on the sensing optical fiber 10 at which the return light is generated against the association table illustrated in FIG. 2.

Therefore, the identification unit 202 identifies return light generated at each of a plurality of points on the road 30 from the return light received by the reception unit 201, and acquires vibration information included in the identified return light. In this way, the identification unit 202 acquires vibration information of each of the plurality of points.

Herein, it is known that a vibration characteristic (for example, a natural frequency, a damping ratio, and the like) of the road 30 changes (for example, the natural frequency decreases) when a pothole is developed due to deterioration. Therefore, the identification unit 202 identifies a change pattern of the vibration characteristic of each of the plurality of points, based on a vibration value at each time indicated by the vibration information of each of the plurality of points. The change pattern of the vibration characteristic is, for example, a pattern indicating a temporal change of the vibration characteristic. Herein, any method can be used in the identification unit 202 as a method of calculating the vibration characteristic from the vibration value at each time. For example, as an example of a method of calculating a natural frequency from the vibration value at each time, a method of calculating the natural frequency by converting, for each predetermined time range, the vibration value at each time into data in a frequency domain is conceivable, but the method of calculating a natural frequency is not limited thereto.

The analysis unit 203 analyzes a deterioration state of at least one of the plurality of points, based on the change pattern of the vibration characteristic of each of the plurality of points on the road 30 identified by the identification unit 202. For example, in a case where the natural frequency is used as the vibration characteristic of the road 30, when there is a point where the natural frequency lowers as compared with other points, the analysis unit 203 can determine that the point is deteriorated.

However, the change pattern of the vibration characteristic of the road 30 depends not only on the deterioration state of the road 30 but also on an ambient condition of the road 30 (for example, such as sunlight, temperature, rainwater, traffic volume, and the like).

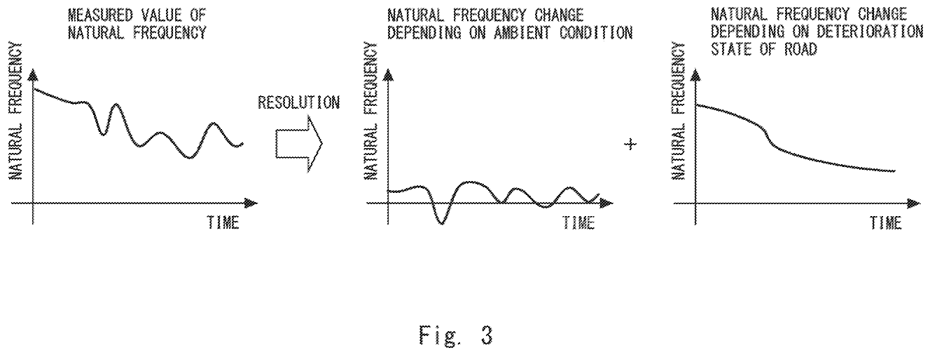

For example, the leftmost graph in FIG. 3 illustrates a change pattern (measured value) indicating a temporal change of a natural frequency of a certain point of the road 30 in a case where the natural frequency is used as the vibration characteristic of the road 30. The change pattern of the natural frequency can be resolved into a change pattern of the natural frequency depending on the ambient condition of the point and a change pattern of the natural frequency depending on a deterioration state of the point.

Therefore, in order to improve accuracy of the analysis of the deterioration state of the point to be analyzed on the road 30, it is preferable to remove the change pattern depending on the ambient condition from a change pattern of a vibration characteristic of a point to be analyzed, and perform the analysis based only on the change pattern depending on the deterioration state.

Herein, when it is assumed that all of the plurality of points on the road 30 are in the same ambient condition, it is considered that the change pattern depending on the ambient condition appears as a common pattern common to the change patterns of the vibration characteristics of the plurality of points.

Therefore, when attempting to analyze the deterioration state of the point to be analyzed, the analysis unit 203 may identify the common pattern common to the change patterns of the vibration characteristics of the plurality of points on the road 30, and analyze the deterioration state of the point to be analyzed, based on the identified common pattern and the change pattern of the vibration characteristic of the point to be analyzed. More specifically, the analysis unit 203 may correct the change pattern of the vibration characteristic of the point to be analyzed, based on the common pattern, and analyze the deterioration state of the point to be analyzed, based on the corrected change pattern of the vibration characteristic of the point to be analyzed. As a result, the deterioration state of the point to be analyzed can be analyzed after an influence of the ambient condition is eliminated, and therefore the accuracy of the analysis can be improved.

However, not all of the plurality of points on the road 30 are in the same ambient condition. For example, since the ambient condition such as sunlight, temperature, rainwater, and the like are greatly different between a point in a tunnel on the road 30 and a point outside the tunnel, it is considered that the change patterns of the vibration characteristics are also greatly different. However, conversely speaking, it is considered that the ambient conditions are the same or similar in points having similar change patterns of the vibration characteristics.

Therefore, the analysis unit 203 may determine a cluster to which each of the plurality of points belongs, in such a way that the points having similar change patterns of the vibration characteristics belong to the same cluster, based on the variation pattern of the vibration characteristic of each of the plurality of points on the road 30. In this case, it is considered that points belonging to the same cluster have the same or similar ambient condition, and a change pattern depending on the ambient condition appears as a common pattern. Therefore, when analyzing the deterioration state of the point to be analyzed, the analysis unit 203 may identify a cluster to which the point to be analyzed belongs, and may identify a common pattern common to the change patterns of the vibration characteristics of one or more points belonging to the identified cluster. Then, the analysis unit 203 may analyze the deterioration state of the point to be analyzed, based on the change pattern of the vibration characteristic of the point to be analyzed and the common pattern of the cluster to which the point to be analyzed belongs. More specifically, the analysis unit 203 may correct the change pattern of the vibration characteristic of the point to be analyzed, based on the common pattern of the cluster to which the point to be analyzed belongs, and analyze the deterioration state of the point to be analyzed, based on the corrected change pattern of the vibration characteristic of the point to be analyzed. As a result, the deterioration state of the point to be analyzed can be analyzed after an influence of the ambient condition is eliminated, and therefore the accuracy of the analysis can be improved.

In the above description, although the analysis unit 203 determines the cluster to which each of the plurality of points belongs, in such a way that the points having similar change patterns of vibration characteristics belong to the same cluster, a method of the determination is not limited thereto. For example, a user may be able to determine similarity between the points, based on prior knowledge of geographic information, design information, and the like. In this case, the user can determine the cluster to which each of the plurality of points belongs, based on the prior knowledge, without the analysis unit 203 having to check similarity between the change patterns of the vibration characteristics. Therefore, the user may instruct the cluster to which each of the plurality of points belongs, and the analysis unit 203 may determine the cluster to which each of the plurality of points belongs, based on the instruction from the user.

Further, the analysis unit 203 may detect a sign of deterioration of at least one of the plurality of points, based on the change pattern of the vibration characteristic of each of the plurality of points on the road 30 identified by the identification unit 202. For example, in a case where the natural frequency is used as the vibration characteristic of the road 30, when there is a point shows a tendency that the natural frequency decreases from an initial state compared to other points, the analysis unit 203 can determine that the point has a sign of deterioration. As a result, it is possible to detect the sign of deterioration of the road 30 at a stage before a pothole due to the deterioration of the road 30 is developed (for example, at a stage at which a crack or a cavity, which will be described later, is developed). Therefore, the road 30 can be repaired at an early stage, and occurrence of a traffic accident caused by the pothole can be prevented in advance.

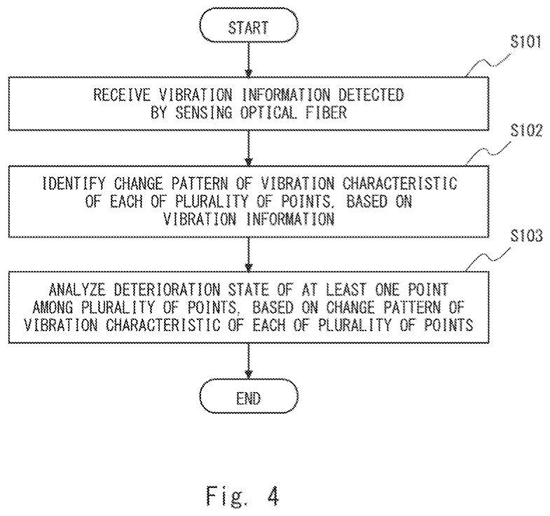

Next, with reference to FIG. 4, an example of an overall operation flow of the structure deterioration detection system according to the first example embodiment will be described.

As illustrated in FIG. 4, the reception unit 201 receives, from the sensing optical fiber 10, return light including vibration information detected by the sensing optical fiber 10 (step S101).

Next, the identification unit 202 identifies a change pattern of vibration characteristic of each of a plurality of points on the road 30, based on the vibration information included in the return light received by the reception unit 201 (step S102).

Thereafter, the analysis unit 203 analyzes a deterioration state of at least one of the plurality of points, based on the change pattern of the vibration characteristic of each of the plurality of points identified by the identification unit 202 (step S103).

As described above, according to the first example embodiment, the reception unit 201 receives the vibration information detected by the sensing optical fiber 10. The identification unit 202 identifies the change pattern of the vibration characteristic of each of the plurality of points on the road 30, based on the vibration information. The analysis unit 203 analyzes the deterioration state of at least one of the plurality of points, based on the change pattern of the vibration characteristic of each of the plurality of points. Therefore, in order to detect a deterioration state of the road 30, it is only necessary to have the sensing optical fiber 10, and it is not necessary for a dedicated probe vehicle to travel on the road 30 as in Patent Literature 1. Therefore, the deterioration state of the road 30 can be detected at low cost.

According to the first example embodiment, an existing communication optical fiber can be used as the sensing optical fiber 10. In this case, no additional equipment for detecting the deterioration state of the road 30 is required, and therefore the structure deterioration detection system can be constructed at low cost.

According to the first example embodiment, an optical fiber sensing technique using the sensing optical fiber 10 as a sensor is used. Therefore, advantages such as no influence of electromagnetic noise, no need for power supply to the sensor, excellent environmental tolerance, and easy maintenance can be acquired.

### Second Example Embodiment

A structure deterioration detection system according to a second example embodiment is a more specific example embodiment of the structure deterioration detection system according to the first example embodiment described above. Specifically, the structure deterioration detection system according to the second example embodiment is achieved by replacing the structure deterioration detection device 20 according to the first example embodiment described above with a structure deterioration detection device 20 A, and an external system configuration is similar to that in the first example embodiment described above.

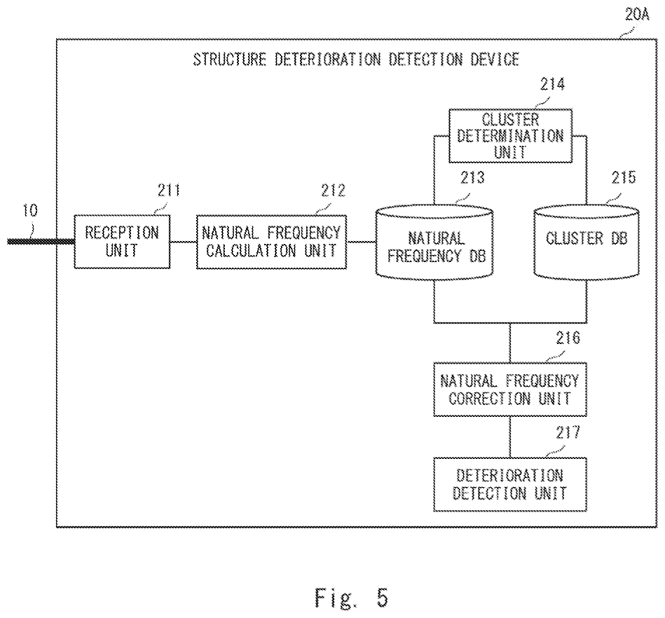

Hereinafter, a configuration example of the structure deterioration detection device 20 A according to the second example embodiment will be described with reference to FIG. 5. It is assumed that a sensing optical fiber 10 illustrated in FIG. 5 is laid on a road 30 in a similar manner as in the first example embodiment described above. The structure deterioration detection device 20A illustrated in FIG. 5 analyzes a deterioration state of a point on the road 30 by using a natural frequency as a vibration characteristic of the road 30.

As illustrated in FIG. 5, the structure deterioration detecting device 20 A according to the second example embodiment includes a reception unit 211, a natural frequency calculation unit 212, a natural frequency DB (Database) 213, a cluster determination unit 214, a cluster DB 215, a natural frequency correction unit 216, and a deterioration detection unit 217.

Herein, the reception unit 211 corresponds to the reception unit 201 in FIG. 1. A combination of the natural frequency calculation unit 212 and the natural frequency DB 213 corresponds to the identification unit 202 in FIG. 1. A combination of the cluster determination unit 214, the cluster DB 215, the natural frequency correction unit 216, and the deterioration detection unit 217 corresponds to the analysis unit 203 in FIG. 1.

The reception unit 211 inputs pulsed light to the sensing optical fiber 10, and receives, as return light, through the sensing optical fiber 10, reflected light and scattered light generated by the pulsed light being transmitted to the sensing optical fiber 10. The return light received by the reception unit 211 includes return light generated at each of a plurality of points on the road 30. Each return light includes vibration information indicating a vibration value at each time of vibration generated at a relevant point.

The natural frequency calculation unit 212 can identify at which position (distance from the structure deterioration detection device 20 A) on the sensing optical fiber 10 the return light is generated, based on, for example, a time difference between when the reception unit 211 transmits the pulsed light to the sensing optical fiber 10 and when the reception unit 211 receives the return light, an intensity of the return light received by the reception unit 211, and the like.

In addition, the natural frequency calculation unit 212 holds in advance an association table (for example, see FIG. 2) in which an identification number for identifying a point and positional information (positional information indicating a distance from the structure deterioration detection device 20) of the point are associated with each other for each of the plurality of points on the road 30.

Therefore, the natural frequency calculation unit 212 can identify at which point on the road 30 the return light is generated by checking a position on the sensing optical fiber 10 where the return light is generated against the association table.

Therefore, the natural frequency calculation unit 212 identifies the return light generated at each of the plurality of points on the road 30 from the return light received by the reception unit 201, and acquires the vibration information included in the identified return light. In this way, the natural frequency calculation unit 212 collects the vibration values at each time of the plurality of points.

Further, the natural frequency calculation unit 212 calculates a natural frequency at each time of each of the plurality of points on the road 30, based on the vibration value at each time of each of the plurality of points. Any method can be used in the natural frequency calculation unit 212 as a method of calculating the natural frequency from the vibration value at each time. As an example of this method, for example, a method of converting, for each predetermined time range, the vibration value at each time into data in a frequency domain and calculating the natural frequency is conceivable, but the method is not limited thereto.

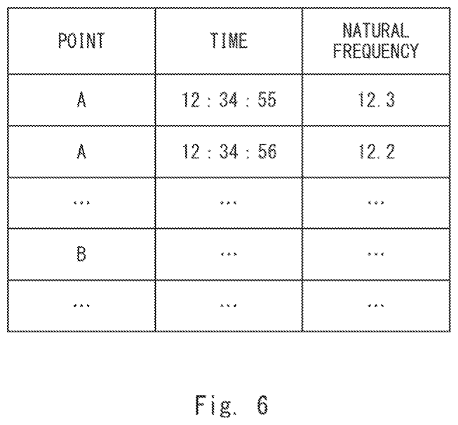

The natural frequency DB 213 is a database in which the natural frequency at each time of each of the plurality of points on the road 30 calculated by the natural frequency calculation unit 212 is registered. FIG. 6 illustrates an example of contents of the natural frequency DB 213. Data registered in the natural frequency DB 213 indicate time-series data indicating a temporal change of the natural frequency of each of the plurality of points, and corresponds to the change pattern indicating a temporal change of the natural frequency of each of the plurality of points in the first example embodiment described above.

The cluster determination unit 214 reads the time-series data of the natural frequency of each of the plurality of points on the road 30 from the natural frequency DB 213, calculates a degree of similarity of the time-series data of the natural frequencies between the plurality of points, and determines a cluster to which each of the plurality of points belongs, in such a way that points having high similarity belong to the same cluster.

However, a method of determining a cluster is not limited to this. For example, a user may be able to determine similarity between the points, based on prior knowledge of geographic information, design information, and the like, and may be able to determine a cluster to which each of the plurality of points belongs. Therefore, the user may instruct a cluster to which each of the plurality of points belongs, and the cluster determination unit 214 may determine a cluster to which each of the plurality of points belongs, based on the instruction from the user.

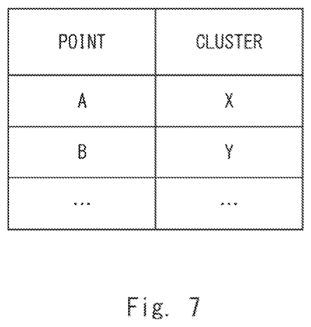

The cluster DB 215 is a database in which a cluster result determined by the cluster determination unit 214, that is, a cluster to which each of the plurality of points on the road 30 belongs is registered. FIG. 7 illustrates an example of contents of the cluster DB 215.

The natural frequency correction unit 216 reads the cluster result from the cluster DB 215, identifies a cluster to which a point to be analyzed among the plurality of points on the road 30 belongs, and confirms one or more points belonging to the identified cluster.

The natural frequency correction unit 216 reads, from the natural frequency DB 213, the time-series data of the natural frequencies of the one or more points belonging to the cluster identified above, and calculates common time-series data common to the read time-series data. The common time-series data correspond to the common pattern common to the change patterns of the natural frequencies of the one or more points belonging to the identified cluster in the first example embodiment.

Further, the natural frequency correction unit 216 corrects the time-series data of the natural frequency of the point to be analyzed, based on the common time-series data calculated above.

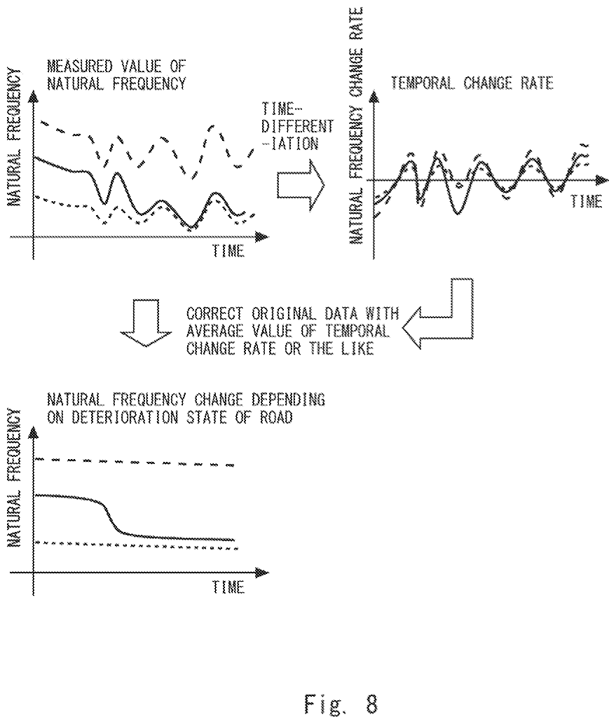

Herein, with reference to FIG. 8, an example of an operation of calculating the common time-series data and an operation of correcting the time-series data of the natural frequency of the point to be analyzed, which are performed in the natural frequency correction unit 216, will be specifically described. FIG. 8 illustrates an example in which three points belong to a cluster to which a point to be analyzed belongs.

As illustrated in FIG. 8, first, the natural frequency correction unit 216 time-differentiates time-series data of a natural frequency of each of the three points, and acquires time-series data of temporal change rate of the natural frequency of each of the three points.

Then, the natural frequency correction unit 216 acquires an average value of the time-series data of the temporal change rates of the natural frequencies of the three points, and sets the acquired average value as a common time-series data. However, a method of calculating the common time-series data is not limited thereto. Since the three points illustrated in FIG. 8 have a high degree of similarity of the time-series data of the natural frequencies, the time-series data of the temporal change rates of the natural frequencies are also similar. Therefore, for example, the natural frequency correction unit 216 may use the time-series data of the temporal change rate of the natural frequency of any one of the three points as the common time-series data.

Then, the natural frequency correction unit 216 corrects the time-series data of the natural frequency of the point to be analyzed among the three points, based on the common time-series data calculated above. The time-series data after the correction is time-series data of the natural frequency in which an influence of an ambient condition of the point to be analyzed is eliminated, and depends on a deterioration state of the point to be analyzed. In FIG. 8, for convenience of description, the time-series data of the natural frequencies are corrected for all three points, but this correction may be performed only for the point to be analyzed.

The deterioration detection unit 217 detects deterioration and a sign of deterioration of the point to be analyzed, based on the corrected time-series data of the natural frequency of the point to be analyzed, which has been corrected by the natural frequency correction unit 216.

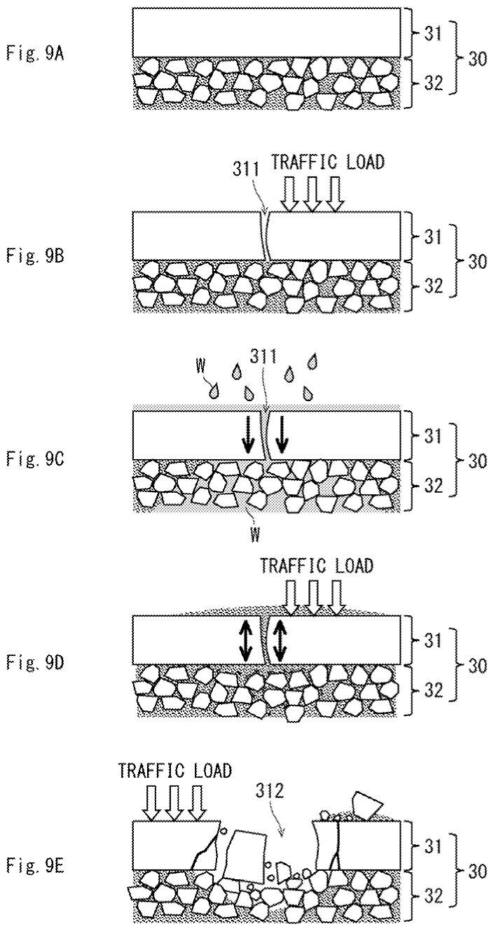

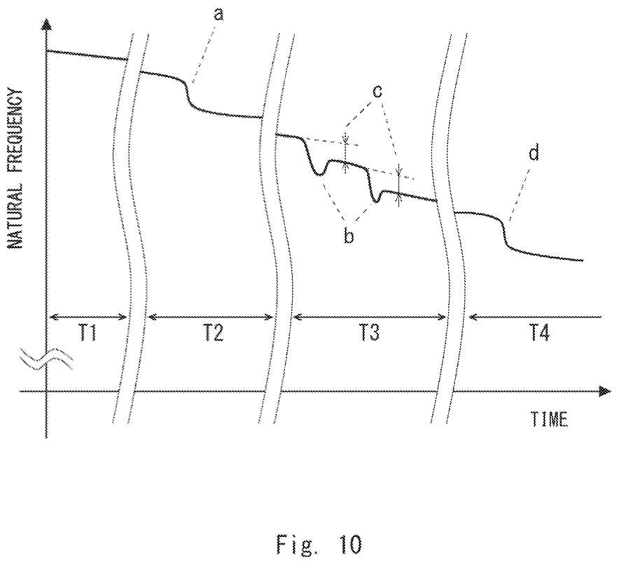

Herein, with reference to FIG. 9 and FIG. 10, an example of an operation of detecting the deterioration and the sign of deterioration of the point to be analyzed, which is performed in the deterioration detection unit 217, will be described in detail.

First, with reference to FIG. 9, an example of a mechanism by which a pothole is developed on the road 30 will be described.

As illustrated in FIG. 9, the road 30 has a structure in which an asphalt pavement layer 31 is formed on a roadbed 32 (FIG. 9(a)). The asphalt pavement layer 31 is affected by a traffic load and the like, and a crack is developed due to aging deterioration, and a cracked part 311 is formed (FIG. 9(b)). Then, during rainfall, rainwater W percolates from the cracked part 311 into the roadbed 32 (FIG. 9(c)). When a traffic load is received in this state, a hopping phenomenon occurs in which fine particles of the roadbed 32 blow out onto a road surface together with the rainwater W percolated into the roadbed 32, and a cavity is developed under the asphalt pavement layer 31 (FIG. 9(d)). When a traffic load is received in this state, the asphalt pavement layer 31 is progressively damaged and fragmented because of the cavity. Then, tires of a vehicle and the fragmented asphalt pavement layer 31 come into close contact with each other during rainfall, and the fragmented asphalt pavement layer 31 pops out onto the road surface. As a result, a pothole 312 is developed (FIG. 9(e)).

Next, with reference to FIG. 10, an example of time-series data of a natural frequency of a point where the pothole 312 is generated is described.

As illustrated in FIG. 10, a natural frequency of a point on the road 30 gradually decreases due to deterioration.

A time region T1 is a stage before a crack develops on the asphalt pavement layer 31, and a large change in the natural frequency is not observed.

In a time region T2, a crack develops on the asphalt pavement layer 31 due to aging deterioration, and the natural frequency greatly decreases (point a).

In a time region T3, during rainfall, rainwater percolates from the cracked part 311 into the roadbed 32, and the natural frequency temporarily decreases significantly (point b). Thereafter, a cavity is generated under the asphalt pavement layer 31 due to the hopping phenomenon. At this occasion, the natural frequency changes before and after the hopping phenomenon, but does not return to the original natural frequency (point c). Thereafter, the points b and c appear again, and the cavity expands.

In a time region T4, the pothole 312 is generated, and the natural frequency significantly decreases (point d).

When detecting the deterioration and the sign of deterioration of the point to be analyzed on the road 30, the deterioration detection unit 217 refers to the corrected time-series data of the natural frequency of the point to be analyzed. Then, for example, when a point corresponding to the point d in the time region T4 in FIG. 10 is detected in the time-series data, the deterioration detection unit 217 can determine that the point to be analyzed is degraded. In addition, when the deterioration detection unit 217 detects a point corresponding to any one of the point a in the time region T2, the point b in the time region T3, or the point c in the time region T3 in FIG. 10 in the time series data, it can be determined that the point to be analyzed has a sign of deterioration.

In addition, the deterioration detection unit 217 may notify an alert when it is determined that the point to be analyzed is degraded or that there is a sign of deterioration. The notification destination of the alert may be, for example, a terminal or the like installed in a traffic control center that monitors the road 30. An alert notification method may be, for example, a method of displaying a graphical user interface (GUI) screen on a display, a monitor, or the like of the terminal being the notification destination, or a method of outputting a message from a speaker of the terminal being the notification destination.

Next, an operation of the structure deterioration detection system according to the second example embodiment will be described.

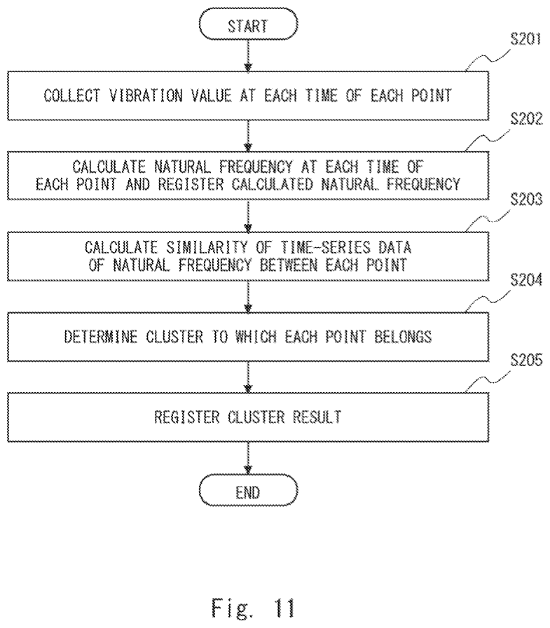

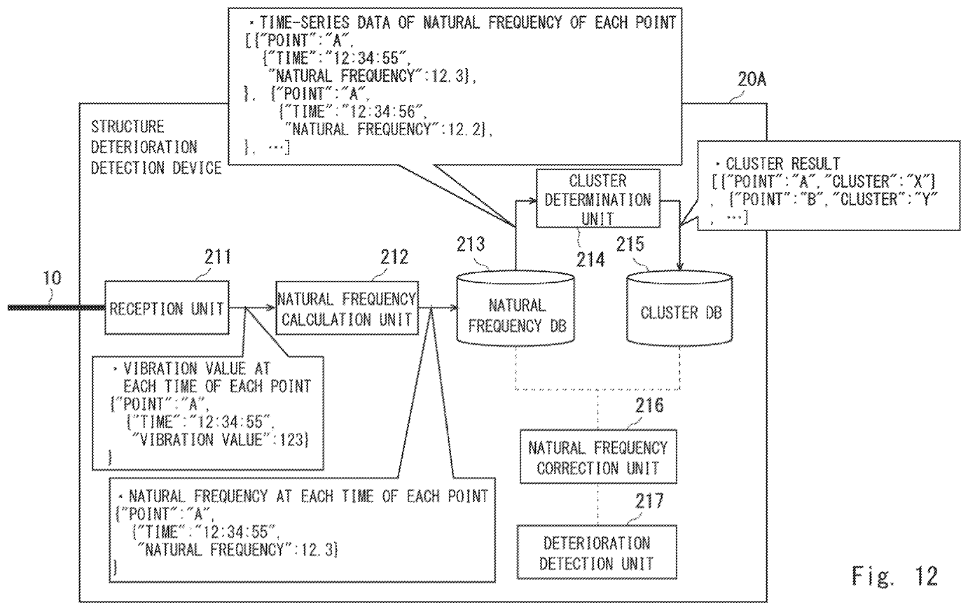

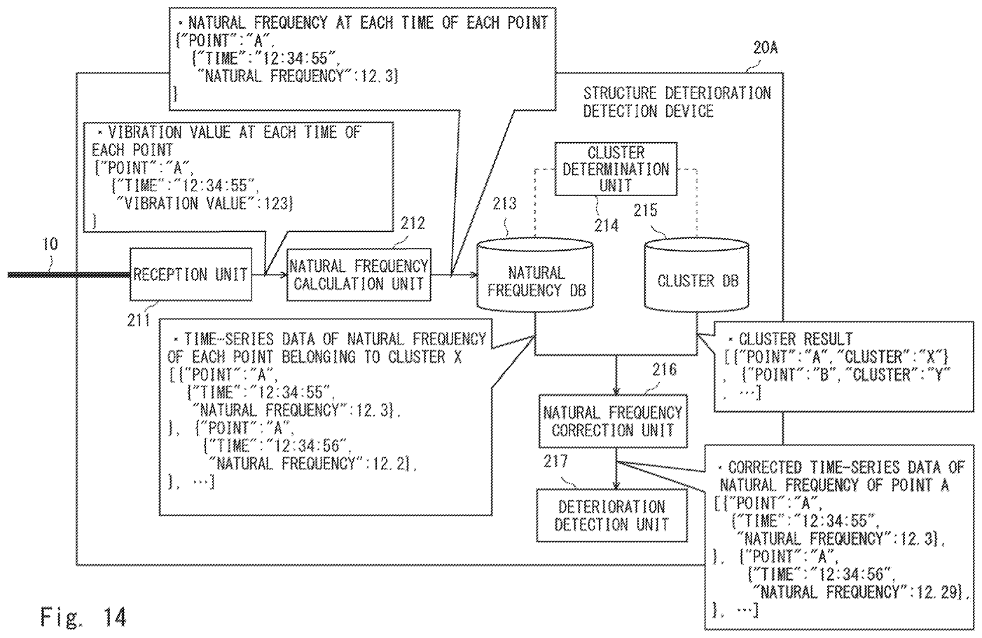

First, with reference to FIG. 11, an example of an operation flow of determining a cluster to which each of the plurality of points on the road 30 belongs will be described. FIG. 12 illustrates an example of information exchanged between components in the structure deterioration detection device 20A during the operation illustrated in FIG. 11. In FIG. 12, among connection lines between the components, a connection line through which the information is exchanged is represented by a solid line, and the other connection lines are represented by a broken line (the same applies in FIG. 14).

As illustrated in FIG. 11, first, the natural frequency calculation unit 212 collects a vibration value at each time of each of the plurality of points on the road 30 from return light received by the reception unit 201 (step S201).

Next, the natural frequency calculation unit 212 calculates a natural frequency at each time of each of the plurality of points, based on the vibration value at each time of each of the plurality of points, and registers a result of the calculation in the natural frequency DB 213 (step S202). An example of contents of the natural frequency DB 213 at this occasion is as illustrated in FIG. 6. Data registered in the natural frequency DB 213 indicates time-series data indicating a temporal change in the natural frequency of each of the plurality of points.

Next, the cluster determination unit 214 reads the time-series data of the natural frequency of each of the plurality of points on the road 30 from the natural frequency DB 213, and calculates a degree of similarity of the time-series data of the natural frequencies between the plurality of points (step S203).

Next, the cluster determination unit 214 determines a cluster to which each of the plurality of points belongs, in such a way that points having a high degree of similarity belong to the same cluster (step S204), and registers the determined cluster result in the cluster DB 215 (step S205). An example of contents of the cluster DB 215 at this occasion is as illustrated in FIG. 7.

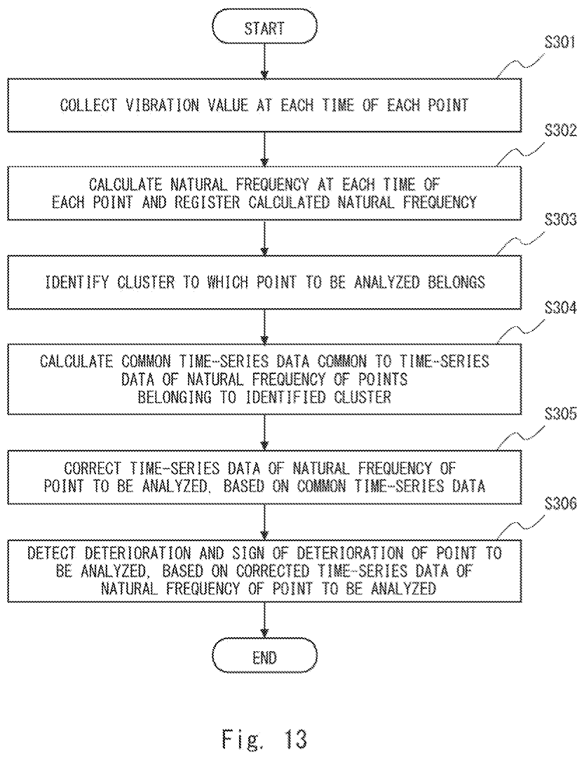

Next, with reference to FIG. 13, an example of an operation flow of detecting deterioration and a sign of deterioration of a point to be analyzed on the road 30 is described. FIG. 14 illustrates an example of information exchanged between the components in the structure deterioration detection device 20A during the operation illustrated in FIG. 13. Herein, it is assumed that the point to be analyzed on the road 30 is a point A.

As illustrated in FIG. 13, first, steps S301 and S302 similar to steps S201 and S202 in FIG. 11 are performed.

Subsequently, the natural frequency correction unit 216 reads a cluster result from the cluster DB 215, identifies a cluster (herein, cluster X) to which the point A to be analyzed on the road 30 belongs, and confirms one or more points belonging to the identified cluster X (step S303).

Subsequently, the natural frequency correction unit 216 reads, from the natural frequency DB 213, time-series data of the natural frequencies of the one or more points belonging to the cluster X identified above, and calculates common time-series data common to the read time-series data (step S304).

Next, the natural frequency correction unit 216 corrects the time-series data of the natural frequency of the point A to be analyzed, based on the common time-series data calculated above (step S305).

Thereafter, the deterioration detection unit 217 detects deterioration and a sign of deterioration of the point A to be analyzed, based on the corrected time-series data of the natural frequency of the point A to be analyzed, which has been corrected by the natural frequency correction unit 216 (step S306).

As described above, according to the second example embodiment, the natural frequency calculation unit 212 calculates the natural frequency at each time of each of the plurality of points on the road 30, based on the vibration value at each time of each of the plurality of points, and generates the time-series data of the natural frequency of each of the plurality of points. The cluster determination unit 214 determines a cluster to which each of the plurality of points belongs, in such a way that points having a high degree of similarity belong to the same cluster. The natural frequency correction unit 216 identifies a cluster to which the point to be analyzed on the road 30 belongs, calculates common time-series data common to time-series data of the natural frequencies of one or more points belonging to the identified cluster, and corrects time-series data of the natural frequency of the point to be analyzed, based on the calculated common time-series data. The deterioration detection unit 217 detects deterioration and a sign of deterioration of the point to be analyzed, based on the corrected time-series data of the natural frequency of the point to be analyzed. Therefore, in order to detect a deterioration state of the road 30, it is only necessary to have the sensing optical fiber 10, and it is not necessary for a dedicated probe vehicle to travel on the road 30 as in Patent Literature 1. Therefore, the deterioration state of the road 30 can be detected at low cost.

Other advantageous effects are similar to those in the first example embodiment described above.

### Hardware Configuration of Structure Deterioration Detection Device According to First and Second Example Embodiments

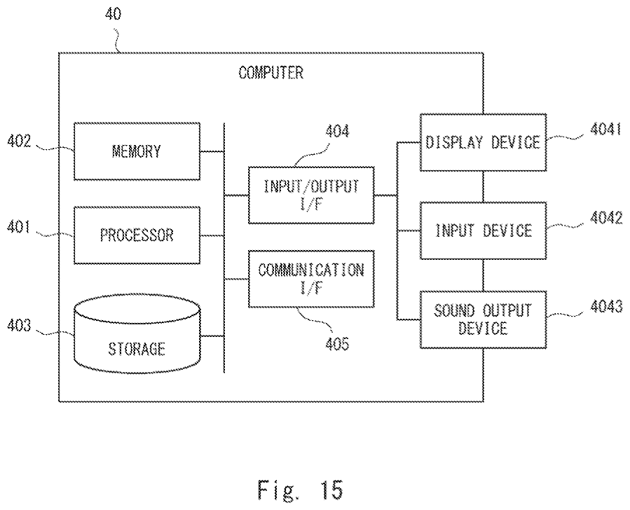

Next, with reference to FIG. 15, a hardware configuration of a computer 40 that achieves the structure deterioration detection devices 20 and 20A according to the first and second example embodiments described above will be described.

As illustrated in FIG. 15, the computer 40 includes a processor 401, a memory 402, a storage 403, an input/output interface (input/output I/F) 404, a communication interface (communication I/F) 405, and the like. The processor 401, the memory 402, the storage 403, the input/output interface 404, and the communication interface 405 are connected to each other through a data transmission path for transmitting and receiving data.

The processor 401 is, for example, an arithmetic processing device such as a central processing unit (CPU) or a graphics processing unit (GPU). The memory 402 is, for example, a random access memory (RAM), a read only memory (ROM), or the like. The storage 403 is, for example, a storage device such as a hard disk drive (HDD), a solid state drive (SSD), or a memory card. Otherwise, the storage 403 may be a memory such as a RAM or a ROM.

The storage 403 stores programs that achieve functions of the components included in the structure deterioration detection devices 20 and 20 A. The processor 401 executes each of the programs and thereby achieves each of the functions of the components included in the structure deterioration detection devices 20 and 20A. Herein, when executing the above-described programs, the processor 401 may execute the programs after reading them onto the memory 402, or may execute the programs without reading them onto the memory 402. The memory 402 and the storage 403 also serve to store information and data held by the components included in the structure deterioration detection devices 20 and 20A.

Also, the programs described above may be stored using various types of non-transitory computer readable medium and supplied to a computer (including the computer 40). The non-transitory computer readable medium includes various types of tangible storage medium. Examples of the non-transitory computer readable medium include a magnetic recording medium (for example, a flexible disk, a magnetic tape, a hard disk drive), a magneto-optical recording medium (for example, a magneto-optical disk), a compact disc-ROM (CD-ROM), a CD-recordable (CD-R), a CD-rewritable (CD-R/W), a semiconductor memory (for example, a mask ROM, a programmable ROM (PROM), an erasable PROM (EPROM), a Flash ROM, and a RAM. The programs may also be supplied to the computer by various types of transitory computer-readable medium. Examples of the transitory computer-readable medium include electrical signals, optical signals, and electromagnetic waves. The transitory computer-readable medium may supply the programs to the computer via a wired or wireless communication path, such as an electrical wire or an optical fiber.

The input/output interface 404 is connected to a display device 4041, an input device 4042, a sound output device 4043, and the like. The display device 4041 is a device that displays a screen corresponding to drawing data processed by the processor 401, such as a liquid crystal display (LCD), cathode ray tube (CRT) display, or a monitor. The input device 4042 is a device that receives an operation input made by an operator, and is, for example, a keyboard, a mouse, a touch sensor, or the like. The display device 4041 and the input device 4042 may be integrated and achieved as a touch panel. The sound output device 4043 is a device for acoustically outputting a sound corresponding to sound data processed by the processor 401, such as a speaker.

The communication interface 405 transmits and receives data to and from an external device. For example, the communication interface 405 communicates with the external device via a wired communication path or a wireless communication path.

Although the present disclosure has been described above with reference to the example embodiments, the present disclosure is not limited to the example embodiments described above. Various modifications that are understood by those skilled in the art may be made to the structure and details of the present disclosure within the scope of the present disclosure.

For example, in first and second example embodiments described above, a plurality of components are provided in the structure deterioration detection devices 20 and 20A, but the present invention is not limited thereto. The components provided in the structure deterioration detection devices 20 and 20A are not limited to being provided in one device, and may be provided in a distributed manner in a plurality of devices.

In the first and second example embodiments described above, the case where the structure to be analyzed is the road 30 has been described as an example, but the present invention is not limited thereto. The structure to be analyzed may be a bridge, a tunnel, a piping, a dam, or the like.

In addition, some or all of the above-described example embodiments may also be described as in the following Supplementary Notes, but are not limited to the following.

(Supplementary Note 1)

A structure deterioration detection system comprising:
a sensing optical fiber laid on a structure;
a reception unit configured to receive vibration information detected by the sensing optical fiber;
an identification unit configured to identify a change pattern of a vibration characteristic of each of a plurality of points on the structure, based on the vibration information; and
an analysis unit configured to analyze a deterioration state of at least one point among the plurality of points, based on a change pattern of a vibration characteristic of each of the plurality of points.

(Supplementary Note 2)

The structure deterioration detection system according to Supplementary Note 1, wherein the analysis unit identifies a common pattern common to a change pattern of a vibration characteristic of each of the plurality of points, and analyzes a deterioration state of a point to be analyzed among the plurality of points, based on a change pattern of a vibration characteristic of the point to be analyzed, and the common pattern.

(Supplementary Note 3)

The structure deterioration detection system according to Supplementary Note 1, wherein the analysis unit determines a cluster to which each of the plurality of points belongs, identifies a cluster to which a point to be analyzed among the plurality of points belongs, identifies a common pattern common to a change pattern of a vibration characteristic of each of one or more points belonging to the identified cluster, and analyzes a deterioration state of the point to be analyzed, based on a change pattern of a vibration characteristic of the point to be analyzed and the common pattern of a cluster to which the point to be analyzed belongs.

(Supplementary Note 4)

The structure deterioration detection system according to Supplementary Note 3, wherein the analysis unit determines a cluster to which each of the plurality of points belongs, in such a way that points having a similar change pattern of a vibration characteristic belong to the same cluster, based on a change pattern of a vibration characteristic of each of the plurality of points.

(Supplementary Note 5)

The structure deterioration detection system according to any one of Supplementary Notes 2 to 4, wherein the analysis unit corrects a change pattern of a vibration characteristic of the point to be analyzed, based on the common pattern, and analyzes a deterioration state of the point to be analyzed, based on the corrected change pattern of the vibration characteristic of the point to be analyzed.

(Supplementary Note 6)

The structure deterioration detection system according to any one of Supplementary Notes 1 to 5, wherein the analysis unit detects a sign of deterioration of at least one point among the plurality of points, based on a change pattern of a vibration characteristic of each of the plurality of points.

(Supplementary Note 7)

The structure deterioration detection system according to any one of Supplementary Notes 1 to 6, wherein the change pattern of the vibration characteristic is a change pattern indicating a temporal change of the vibration characteristic.

(Supplementary Note 8)

The structure deterioration detection system according to any one of Supplementary Notes 1 to 7, wherein the vibration characteristic is a natural frequency.

(Supplementary Note 9)

A structure deterioration detection method performed by a structure deterioration detection system, comprising:
a reception step of receiving vibration information detected by a sensing optical fiber laid on a structure;
an identification step of identifying a change pattern of a vibration characteristic of each of a plurality of points on the structure, based on the vibration information; and
an analysis step of analyzing a deterioration state of at least one point among the plurality of points, based on a change pattern of a vibration characteristic of each of the plurality of points.

(Supplementary Note 10)

The structure deterioration detection method according to Supplementary Note 9, wherein the analysis step includes: identifying a common pattern common to a change pattern of a vibration characteristic of each of the plurality of points; and analyzing a deterioration state of a point to be analyzed among the plurality of points, based on a change pattern of a vibration characteristic of the point to be analyzed, and the common pattern.

(Supplementary Note 11)

The structure deterioration detection method according to Supplementary Note 9, wherein the analysis step includes: determining a cluster to which each of the plurality of points belongs; identifying a cluster to which a point to be analyzed among the plurality of points belongs, and identifying a common pattern common to a change pattern of a vibration characteristic of each of one or more points belonging to the identified cluster; and analyzing a deterioration state of the point to be analyzed, based on a change pattern of a vibration characteristic of the point to be analyzed and the common pattern of a cluster to which the point to be analyzed belongs.

(Supplementary Note 12)

The structure deterioration detection method according to Supplementary Note 11, wherein the analysis step includes determining a cluster to which each of the plurality of points belongs, in such a way that points having a similar change pattern of a vibration characteristic belong to the same cluster, based on a change pattern of a vibration characteristic of each of the plurality of points.

(Supplementary Note 13)

The structure deterioration detection method according to any one of Supplementary Notes 10 to 12, wherein the analysis step includes: correcting a change pattern of a vibration characteristic of the point to be analyzed, based on the common pattern; and analyzing a deterioration state of the point to be analyzed, based on the corrected change pattern of the vibration characteristic of the point to be analyzed.

(Supplementary Note 14)

The structure deterioration detection method according to any one of

Supplementary Notes 9 to 13, wherein the analysis step includes detecting a sign of deterioration of at least one point among the plurality of points, based on a change pattern of a vibration characteristic of each of the plurality of points.

(Supplementary Note 15)

The structure deterioration detection method according to any one of

Supplementary Notes 9 to 14, wherein the change pattern of the vibration characteristic is a change pattern indicating a temporal change of the vibration characteristic.

(Supplementary Note 16)

The structure deterioration detection method according to any one of

Supplementary Notes 9 to 15, wherein the vibration characteristic is a natural frequency.

(Supplementary Note 17)

A structure deterioration detection device comprising:
a reception unit configured to receive vibration information detected by a sensing optical fiber laid on a structure;
an identification unit configured to identify a change pattern of a vibration characteristic of each of a plurality of points on the structure, based on the vibration information; and
an analysis unit configured to analyze a deterioration state of at least one point among the plurality of points, based on a change pattern of a vibration characteristic of each of the plurality of points.

### REFERENCE SIGNS LIST

10 Sensing optical fiber
20, 20A Structure deterioration detection device
201 Reception unit
202 Identification unit
203 Analysis unit
211 Reception unit
212 Natural frequency calculation unit
213 Natural frequency DB
214 Cluster determination unit
215 Cluster DB
216 Natural frequency correction unit
217 Deterioration detection unit
Road
31 Asphalt pavement layer
311 Cracked part
312 Pothole
32 Roadbed
W Rainwater
Computer
401 Processor
402 Memory
403 Storage
404 Input/output interface
4041 Display device
4042 Input device
4043 Sound output device
405 Communication interface

What is claimed is:

1. A structure deterioration detection system comprising:
a sensing optical fiber laid on a structure;
a reception unit configured to receive vibration information detected by the sensing optical fiber;
an identification unit configured to identify a change pattern of a vibration characteristic of each of a plurality of points on the structure, based on the vibration information; and
an analysis unit configured to analyze a deterioration state of at least one point among the plurality of points, based on a change pattern of a vibration characteristic of each of the plurality of points.

2. The structure deterioration detection system according to claim 1, wherein the analysis unit identifies a common pattern common to a change pattern of a vibration characteristic of each of the plurality of points, and analyzes a deterioration state of a point to be analyzed among the plurality of points, based on a change pattern of a vibration characteristic of the point to be analyzed, and the common pattern.

3. The structure deterioration detection system according to claim 1, wherein the analysis unit determines a cluster to which each of the plurality of points belongs, identifies a cluster to which a point to be analyzed among the plurality of points belongs, identifies a common pattern common to a change pattern of a vibration characteristic of each of one or more points belonging to the identified cluster, and analyzes a deterioration state of the point to be analyzed, based on a change pattern of a vibration characteristic of the point to be analyzed and the common pattern of a cluster to which the point to be analyzed belongs.

4. The structure deterioration detection system according to claim 3, wherein the analysis unit determines a cluster to which each of the plurality of points belongs, in such a way that points having a similar change pattern of a vibration characteristic belong to the same cluster, based on a change pattern of a vibration characteristic of each of the plurality of points.

5. The structure deterioration detection system according to claim 2, wherein the analysis unit corrects a change pattern of a vibration characteristic of the point to be analyzed, based on the common pattern, and analyzes a deterioration state of the point to be analyzed, based on the corrected change pattern of the vibration characteristic of the point to be analyzed.

6. The structure deterioration detection system according to claim 1, wherein the analysis unit detects a sign of deterioration of at least one point among the plurality of points, based on a change pattern of a vibration characteristic of each of the plurality of points.

7. The structure deterioration detection system according to claim 1, wherein the change pattern of the vibration characteristic is a change pattern indicating a temporal change of the vibration characteristic.

8. The structure deterioration detection system according to claim 1, wherein the vibration characteristic is a natural frequency.

9. A structure deterioration detection method performed by a structure deterioration detection system, comprising:
a reception step of receiving vibration information detected by a sensing optical fiber laid on a structure;
an identification step of identifying a change pattern of a vibration characteristic of each of a plurality of points on the structure, based on the vibration information; and
an analysis step of analyzing a deterioration state of at least one point among the plurality of points, based on a change pattern of a vibration characteristic of each of the plurality of points.

10. The structure deterioration detection method according to claim 9, wherein the analysis step includes: identifying a common pattern common to a change pattern of a vibration characteristic of each of the plurality of points; and analyzing a deterioration state of a point to be analyzed among the plurality of points, based on a change pattern of a vibration characteristic of the point to be analyzed, and the common pattern.

11. The structure deterioration detection method according to claim 9, wherein the analysis step includes: determining a cluster to which each of the plurality of points belongs; identifying a cluster to which a point to be analyzed among the plurality of points belongs, and identifying a common pattern common to a change pattern of a vibration characteristic of each of one or more points belonging to the identified cluster; and analyzing a deterioration state of the point to be analyzed, based on a change pattern of a vibration characteristic of the point to be analyzed and the common pattern of a cluster to which the point to be analyzed belongs.

12. The structure deterioration detection method according to claim 11, wherein the analysis step includes determining a cluster to which each of the plurality of points belongs, in such a way that points having a similar change pattern of a vibration characteristic belong to the same cluster, based on a change pattern of a vibration characteristic of each of the plurality of points.

13. The structure deterioration detection method according to claim 10, wherein the analysis step includes: correcting a change pattern of a vibration characteristic of the point to be analyzed, based on the common pattern; and analyzing a deterioration state of the point to be analyzed, based on the corrected change pattern of the vibration characteristic of the point to be analyzed.

14. The structure deterioration detection method according to claim 9, wherein the analysis step includes detecting a sign of deterioration of at least one point among the plurality of points, based on a change pattern of a vibration characteristic of each of the plurality of points.

15. The structure deterioration detection method according to claim 9, wherein the change pattern of the vibration characteristic is a change pattern indicating a temporal change of the vibration characteristic.

16. The structure deterioration detection method according to claim 9, wherein the vibration characteristic is a natural frequency.

17. A structure deterioration detection device comprising:
a reception unit configured to receive vibration information detected by a sensing optical fiber laid on a structure;
an identification unit configured to identify a change pattern of a vibration characteristic of each of a plurality of points on the structure, based on the vibration information; and
an analysis unit configured to analyze a deterioration state of at least one point among the plurality of points, based on a change pattern of a vibration characteristic of each of the plurality of points.
